(19) United States
(12) Patent Application Publication
(10) Pub. No.: US 2002/0042908 A1
(43) Pub. Date: Apr. 11, 2002

(54) Compiler parallelizing schedule method

(76) Inventors: Kiyosi Ito, Tokyo (JP); Yoshihito Tomii, Tokyo (JP); Yoshiki Iwama, Tokyo (JP); Naoyuki Uekusa, Tokyo (JP); Yasuo Satou, Tokyo (JP)

Correspondence Address: STAAS & HALSEY LLP, 700 11TH STREET, NW, SUITE 500, WASHINGTON, DC, 20001, US

(21) Appl. No.: 09/804,031

(22) Filed: Mar. 13, 2001

(30) Foreign Application Priority Data
Oct. 10, 2000 (JP) 2000-309759

(51) Int. Cl. G06F 9/45

(52) U.S. Cl. 717/149

(57) ABSTRACT

Commands are classified for each of conventional priority values. It is checked if there is any issue limitation between commands having the same priority value. For command group having issue limitation, it is checked if there is any delay due to the issue limitation. Reverse priority is calculated from an optimizing target group consisting of the commands having a delay due to the issue limitation to a neck command that is a common precedent command of the commands within the optimizing target group, and based upon the reverse priority values, priority calculations are again executed, thereby carrying out a slot mapping process.

### FIELD OF THE INVENTION

The present invention in general relates to a compiler parallelizing schedule method. More particularly, this invention relates to a VLIW (Very Long Instruction Word) architecture-use compiler parallelizing schedule method.

### BACKGROUND OF THE INVENTION

A compiler which generates object codes for a computer has a plurality of operation units. These units operate in parallel with each other. Conventionally, in order to enhance the efficiency of the object codes, a scheduling process, which can process different commands in parallel with each other in a plurality of operation units, has been carried out.

For example, Japanese Patent Application Laid-Open (JP-A) No. 10-207854 has disclosed a compiler parallelizing schedule method. In this schedule method, the mutual dependence and parallel operation suppression relationship between commands are represented by a dependence and parallel operation suppression graph, and based upon this, the pass latency and parallel operation suppressing number are calculated, and based upon the dependence and parallel operation suppression graph to which the results of the calculations are added, the parallel scheduling process for the object codes is carried out.

However, in the conventional schedule method, the parallel operation suppression relationship and parallel operation suppressing number are examined with respect to nodes of all the commands so that the process takes a long time; therefore, the resulting problem is that the time required for the parallelizing process for the object codes becomes long. Moreover, in the above-mentioned conventional schedule method, the weighting value to be applied to the commands is only one kind, that is, the parallel operation suppressing number, with the result that the degree of parallelism is not increased sufficiently and a further improvement of the degree of parallelism is required.

### SUMMARY OF THE INVENTION

It is an objective of this invention to provide a compiler parallelizing schedule method which relates to a compiler for generating object codes for a computer having a plurality of operation units capable of operating in parallel with each other, and which improves the degree of parallelism of the object codes, and carries out a parallelizing process on the object codes at high speeds.

The compiler parallelizing schedule method according to one aspect of this invention comprises following steps. That is, classifying commands for each of conventional priority values; examining whether or not there is any issue limitation between commands having the same priority values; with respect to a command group having any issue limitation, examining whether or not there is any delay due to the issue limitation; carrying out a reverse priority calculation with respect to commands from an optimizing target group consisting of command groups having any delay due to the issue limitation to a neck command that is a common precedent command for the commands within the optimizing target group; based upon the reverse priority value, applying a first weighting value (advantage) to commands from the optimizing target group to the neck command, while applying a second weighting value (weight) to precedent commands preceding the neck command; and again carrying out a priority calculation, taking the weighting values into consideration, so that a slot-mapping process is carried out on each of the commands based upon the new priority value.

According to the above-mentioned aspect, with respect to the command group classified for each of the conventional priority values, it is examined whether or not there is any issue limitation between commands within each command group, and with respect to a command group having any issue limitation, it is examined whether or not there is any delay due to the issue limitation; therefore, as compared with a case in which the parallel operation suppression relationship is examined with respect to nodes of all the commands, it is possible to carry out a parallelizing process on the object codes at higher speeds.

Moreover, the reverse priority calculations and the calculations for applying the first weighting value (advantage) are executed in a range from the optimizing target group to the neck command; therefore, as compared with a case in which the parallel operation suppression relationship is examined with respect to nodes of all the commands, it is possible to carry out a parallelizing processon the object codes at higher speeds.

Furthermore, the first weighting value (advantage) is applied to the commands from the optimizing target group to the neck command, and the second weighting value (weight) is applied to the precedent commands preceding the neck command; therefore, as compared with a case in which the weighting value to be applied to the commands is only the parallel operation suppressing number, it is possible to improve the degree of parallelism in the object codes.

Other objects and features of this invention will become apparent from the following description with reference to the accompanying drawings.

### BRIEF DESCRIPTION OF THE DRAWINGS

FIG. 1 is a flowchart that schematically shows a compiler parallelizing schedule method in accordance with the present invention;

FIG. 2 is a schematic drawing that explains the outline of the compiler parallelizing schedule method in accordance with the present invention;

FIG. 3 is a diagram that explains the outline of the compiler parallelizing schedule method in accordance with the present invention;

FIG. 4 is a diagram that explains the outline of the compiler parallelizing schedule method in accordance with the present invention;

FIG. 5 is a schematic drawing that explains the outline of the compiler parallelizing schedule method in accordance with the present invention;

FIG. 6 is a diagram that explains the outline of the compiler parallelizing schedule method in accordance with the present invention;

FIG. 7 is a schematic drawing that explains the outline of the compiler parallelizing schedule method in accordance with the present invention;

FIG. 8 is a schematic drawing that explains the outline of the compiler parallelizing schedule method in accordance with the present invention;

FIG. 9 is a detailed flowchart that shows the compiler parallelizing schedule method in accordance with the present invention;

FIG. 10 is a schematic drawing that explains the compiler parallelizing schedule method in accordance with the present invention in detail;

FIG. 11 is a detailed diagram that explains the compiler parallelizing schedule method in accordance with the present invention;

FIG. 12 is a detailed diagram that explains the compiler parallelizing schedule method in accordance with the present invention;

FIG. 13 is a schematic drawing that explains the compiler parallelizing schedule method in accordance with the present invention in detail;

FIG. 14 is a detailed diagram that explains the compiler parallelizing schedule method in accordance with the present invention;

FIG. 15 is a detailed diagram that explains the compiler parallelizing schedule method in accordance with the present invention;

FIG. 16 is a detailed diagram that explains the compiler parallelizing schedule method in accordance with the present invention;

FIG. 17 is a schematic drawing that explains the compiler parallelizing schedule method in accordance with the present invention in detail;

FIG. 18 is a schematic drawing that explains the compiler parallelizing schedule method in accordance with the present invention in detail;

FIG. 19 is a schematic drawing that explains the compiler parallelizing schedule method in accordance with the present invention in detail;

FIG. 20 is a schematic drawing that explains the compiler parallelizing schedule method in accordance with the present invention in detail;

FIG. 21 is a schematic drawing that explains the compiler parallelizing schedule method in accordance with the present invention in detail;

FIG. 22 is a schematic drawing that explains the compiler parallelizing schedule method in accordance with the present invention in detail;

FIG. 23 is a schematic drawing that explains the compiler parallelizing schedule method in accordance with the present invention in detail;

FIG. 24 is a schematic drawing that explains the compiler parallelizing schedule method in accordance with the present invention in detail;

FIG. 25 is a schematic drawing that explains a case in which an optimizing process for issue limitation is not executed in the compiler parallelizing schedule method in accordance with the present invention;

FIG. 26 is a schematic drawing that explains a case in which an optimizing process for issue limitation is not executed in the compiler parallelizing schedule method in accordance with the present invention; and

FIG. 27 is a schematic drawing that explains a case in which an optimizing process for issue limitation is not executed in the compiler parallelizing schedule method in accordance with the present invention.

### DESCRIPTION OF THE PREFERRED EMBODIMENTS

Preferred embodiments of the present invention are explained below with reference to the accompanying drawings.

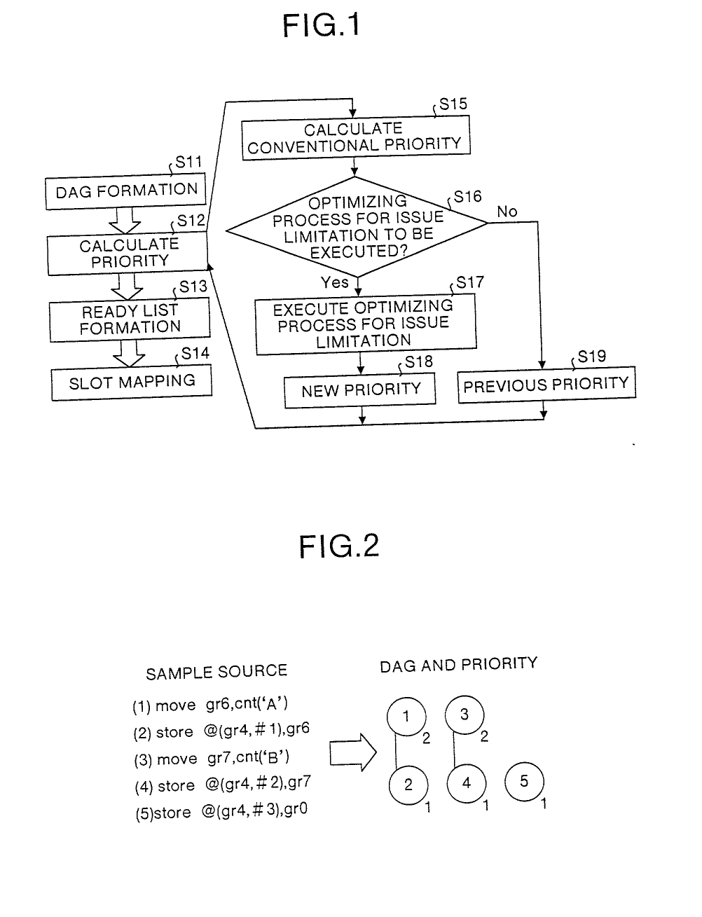

First, referring to a simplified model, an explanation will be given of the outline of a compiler parallelizing schedule method in accordance with the present invention. FIG. 1 is a flowchart that shows an outline of the compiler parallelizing schedule method in accordance with the present invention. Moreover, FIG. 2 to FIG. 8 are schematic drawings or diagrams that explain the outline of the compiler parallelizing schedule method of the present invention.

First, a directed acyclic graph indicating mutual dependence between commands (hereinafter, referred to as DAG) is formed (step S11), and a priority calculation is carried out (step S12). Upon carrying out the priority calculation, first, based upon the DAG formed in step S11, conventional priority calculations are carried out (step S15).

FIG. 2 shows a model of sample sources simplified for convenience of explanation, and the results of the formation of DAG and priority calculations that have been executed on the source. In FIG. 2, model sample sources are shown on the left side of an arrow in the center, and the DAG and priority values of the model are shown on the right side.

In the model shown in FIG. 2, command 1 (indicated by (1)) is dependent on command 2 (indicated by (2)), and command 3 (indicated by (3)) is dependent on command 4 (indicated by (4)). There is no mutual dependence between command 5 (indicated by (5)) and the other commands. In the DAG, a line connecting command 1 and command 2 and a line connecting command 3 and command 4 indicate the above-mentioned mutual dependences (the same is true for DAGs in the other figures) respectively. Moreover, command 2, command 4 and command 5 are storing commands, and in this case, it is assumed that there is a limitation in which, for example, of two I0 slot and I1 slot, each command is only issued in the I0 slot.

As the results of the conventional priority calculations, each of the priority values of command 2, command 4 and command 5 is 1, and each of the priority values of command 1 and 3 is 2. This is because, in the conventional priority calculations, the priority value of a command that is not followed by a succeeding command is set to 1, and for example, to this is successively added 1 by 1 in the direction from the succeeding commands to the preceding commands. Here, the added value is set to 1 because of the following reason. That is, the priority value of a command is found by adding an issue latency and a penalty to the priority value of the command succeeding the command in question, and for simplicity of explanation, it is assumed that the issue latency is 1 and the penalty is 0 (zero). Here, in the DAG, the figures, located lower right of (1) to (5) representing nodes of the respective commands, indicate priority values of the respective commands.

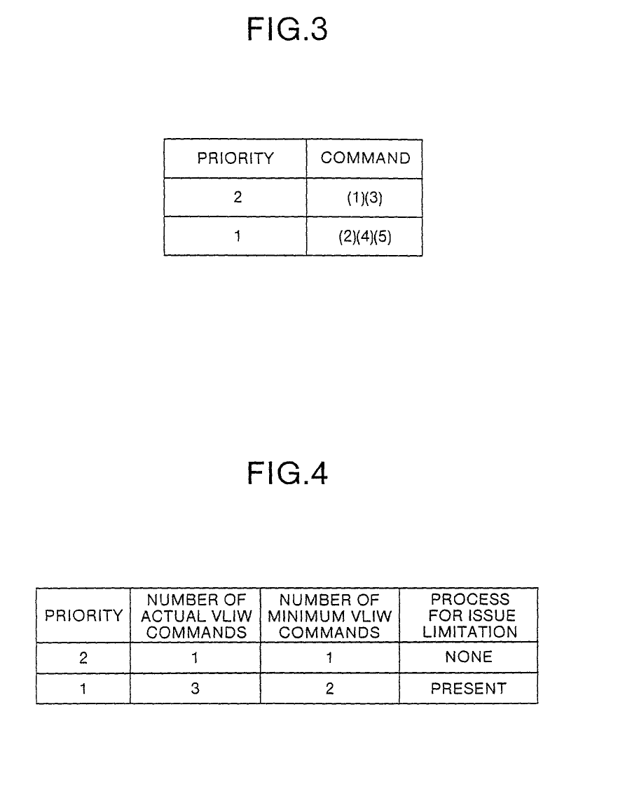

Here, returning to FIG. 1, a judgment is made as to whether or not an optimizing process for issue limitation is executed (step S16), following the conventional priority calculations (step S15). More specifically, as illustrated in FIG. 3, a priority table is formed in which commands are classified for each of the priority values obtained by the conventional priority calculations. Then, the number of VLIW commands (referred to as actual number of VLIW commands), which is required for mapping the commands having the same priority value while taking into consideration the mapping limitation of the slot, is found.

Moreover, the number of VLIW commands (referred to as the minimum number of VLIW commands), which is required for issuing the same number of commands as that of the commands having the same priority value in case of no mapping limitation of the slot, is found. Here, the minimum number of VLIW commands is found by the following equation (1):

[minimum number of VLIW commands]=[number of commands having the same priority value]/[number of slots]+[remainder] (1)

The number of actual VLIW commands is compared with the number of minimum VLIW commands so as to examine whether or not there is any issue limitation between the commands having the same priority value. As the results of the comparison between the number of actual VLIW commands and the number of minimum VLIW commands, when the following equation (2) is satisfied, it is judged that the optimizing process for issue limitation is required. When the following equation (2) is not satisfied, it is judged that the optimizing process for issue limitation is not required.

[number of actual VLIW commands]>[number of minimum VLIW commands] (2)

In case of the model shown in FIG. 2, as shown in FIG. 4, in the command group having a priority value of 2, both of the number of actual VLIW commands and the number of minimum VLIW commands are set to 1; therefore, the equation (2) is not satisfied so that the optimizing process for issue limitation is not required. However, in the command group having a priority value of 1, the number of actual VLIW commands is 3, while the number of minimum VLIW commands is 2; therefore, the equation (2) is satisfied. Thus, in this model, the optimizing process for issue limitation is required.

Returning to FIG. 1, the optimizing process for issue limitation is executed (step S17). More specifically, a reverse priority value corresponding to the shortest command ending time for each of the commands is found. The reverse priority value is found as follows: the priority value of a command that is not preceded by any command is set to a reverse priority 1, and for example, to this is successively added 1 by 1 in the direction from the command in question toward the succeeding commands. This calculation is referred to as the reverse priority calculation. Here, the added value is set to 1 because of the following reason: the reverse priority value of a command is found by the following equation (3), and for simplicity of explanation, it is assumed that the latency of the present DAG is 1 and the penalties of the precedent command and the present DAG are 0 (zero).

[reverse priority value]=[maximum reverse priority value in preceding command group]+[latency of present DAG]+[penalties of precedent command and present DAG] (3)

FIG. 5 shows the results of reverse priority calculations with respect to the model shown in FIG. 2. In the DAG shown in FIG. 5, the figures, located lower right of (1) to (5) representing nodes of the respective commands, indicate conventional priority values of the respective commands, and those located lower left thereof are reverse priority values of the respective commands. As shown in FIG. 5, each of the reverse priority values of command 1, command 3 and command 5 is 1, and each of the reverse priority values of command 2 and command 4 is 2.

Successively, weighting values are applied to the command group with the issue limitation, having a priority value of 1, that is, to command 2, command 4 and command 5. In this case, with respect to the command having the minimum reverse priority value, a value obtained by subtracting 1 from the number of actual VLIW commands is applied thereto as a weighting value. Here, as the reverse priority value increases, the weighting value is reduced 1 by 1 in succession. Here, among the commands having the same reverse priority value, that which is generated earlier is allowed to have a greater weighting value.

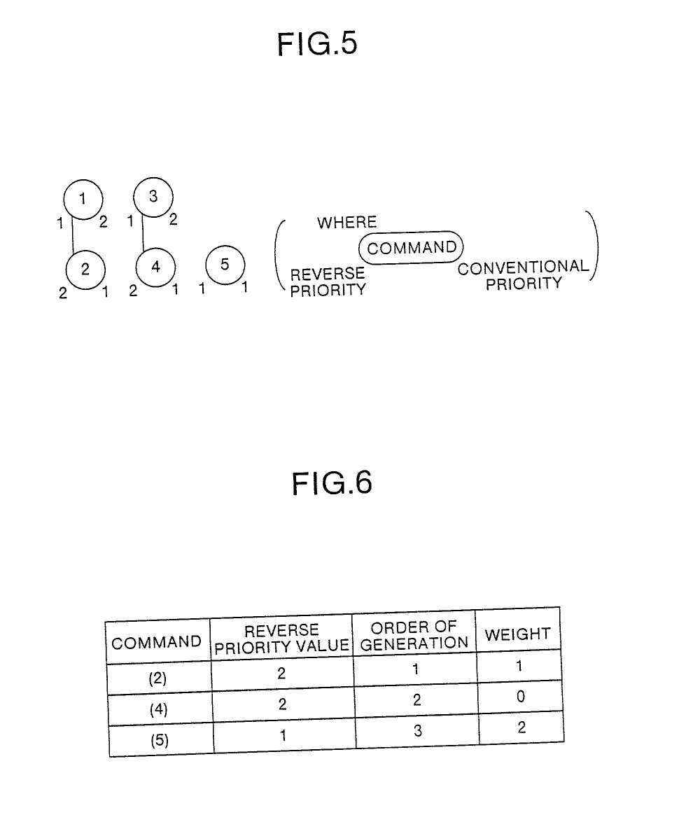

In case of the model shown in FIG. 2, since the number of actual VLIW commands is 3, the weighting value of command 5 having the smallest reverse priority value is set to 2, as collectively shown in FIG. 6. Moreover, of command 2 and command 4 having a reverse priority value of 2, the weighting value of command 2 that is generated earlier is set to 1. Consequently, the weighting value of command 4 is 0 (zero).

Returning to FIG. 1, priority calculations are again executed, while taking into consideration the weighting values that have been applied to the respective commands contained in the command group with the issue limitation; thus, new priority values are obtained (step S18). Here, the new priority value is obtained by the following equation (4):

[new priority value]=[priority value of succeeding command]+[issue latency]+[penalty]+[weighting value] (4)

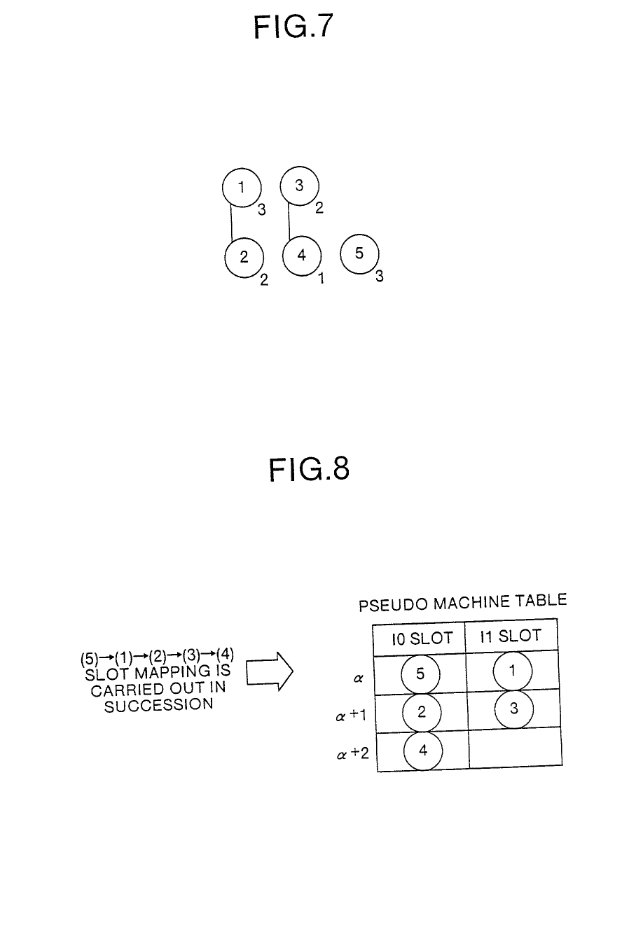

Here, as described above, in this model, for simplicity of explanation, it is assumed that the issue latency is 1 and the penalty is 0 (zero). With respect to the model shown in FIG. 2, in the DAG shown in FIG. 7, the figures, located lower right of (1) to (5) representing nodes of the respective commands, indicate new priority values of the respective commands. In other words, the new priority value of command 1 and command 5 are 3. The new priority value of command 2 and command 3 is 2. The new priority value of command 4 is 1.

Returning to FIG. 1, based upon the new priority values of the respective commands, a ready list is formed (step S13), and a slot mapping process is executed (step S14), thereby completing the scheduling. In the model shown in FIG. 2, as illustrated in FIG. 8, the slot mapping process is carried out in the order of command 5, command 1, command 2, command 3 and command 4. Therefore, the mapping is made in an inner table (pseudo-machine table) in the compiler as follows: in a certain cycle, I0 slot and I1 slot respectively issue command 5 and command 1, and in the next cycle, I0 slot and I1 slot respectively issue command 2 and command 3, and in the next cycle, I0 slot then issues command 4.

Here, when, at step S16, the judgment shows that the optimizing process for issue limitation is not required, the previous priority values, calculated at step S15, are set to priority values for the succeeding processes (step S19), and by using these, a ready list is formed (step S13) and a slot mapping process (step S14) is executed, thereby completing the scheduling.

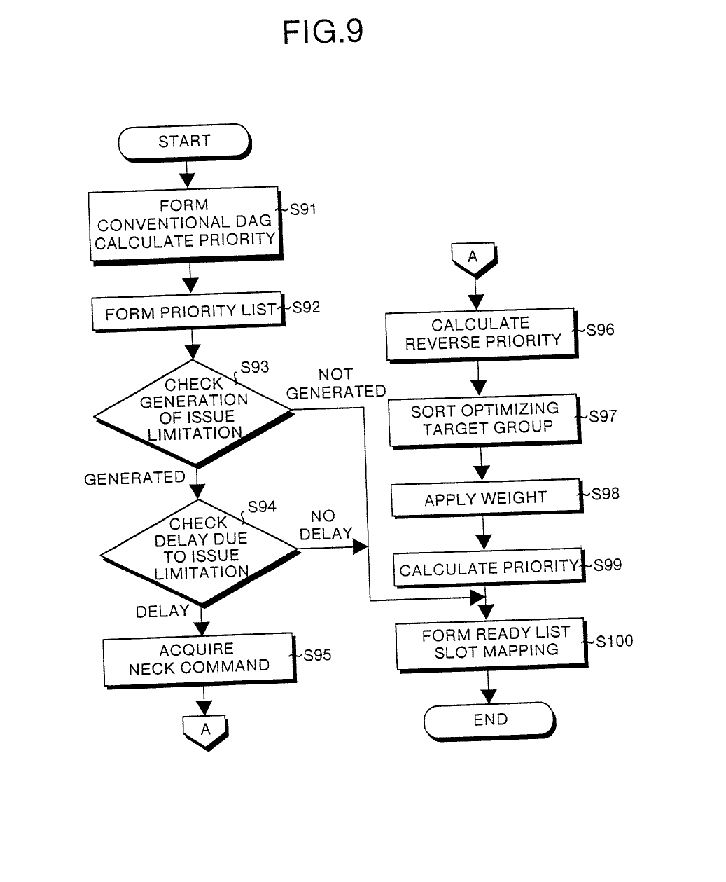

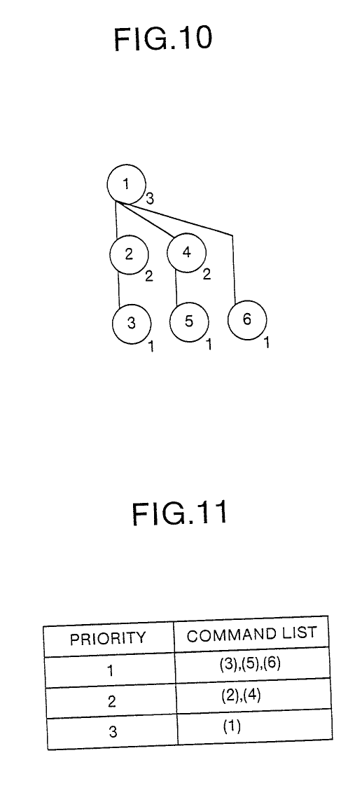

Next, the following description will discuss the compiler parallelizing schedule method of the present invention in detail by exemplifying a more specific model. FIG. 9 is a flowchart that shows the compiler parallelizing schedule method of the present invention in detail. Moreover, FIGS. 10 to 19 are schematic drawings or diagrams for explaining the compiler parallelizing schedule method of the present invention in detail.

First, as described in the outline of the process, a DAG is formed, and conventional priority calculations are executed (step S91). FIG. 10 shows a model DAG and examples of priority values of respective commands. In this model, command 1 (indicated by (1)) is dependent on command 2 (indicated by (2)), command 4 (indicated by (4)) and command 6 (indicated by (6)). Moreover, command 2 is dependent on command 3 (indicated by (3)). Command 4 is dependent on command 5 (indicated by (5)). Here, command 3, command 5 and command 6 are storing commands, and for example, it is assumed that there is a limitation by which these are issued only by I0 slot of two slots, I0 slot and I1 slot. For simplicity of explanation, it is assumed that the issue latency and the penalty are respectively set to 1 and 0 (zero).

As the results of the conventional priority calculations, the priority value of command 1 is 3, each of the priority values of command 2 and command 4 is 2, and each of the priority values of command 3, command 5 and command 6 is 1. With respect to the conventional priority calculations, the outline of the processes has been explained; therefore, the description thereof is omitted. Here, in the DAG shown in FIG. 10, the figures, located lower right of (1) to (6) representing nodes of the respective commands, indicate priority values of the respective commands. Here, returning to FIG. 9, the commands are classified for each of the conventional priority values so that a priority table is formed (step S92). The priority table thus formed is shown in FIG. 11.

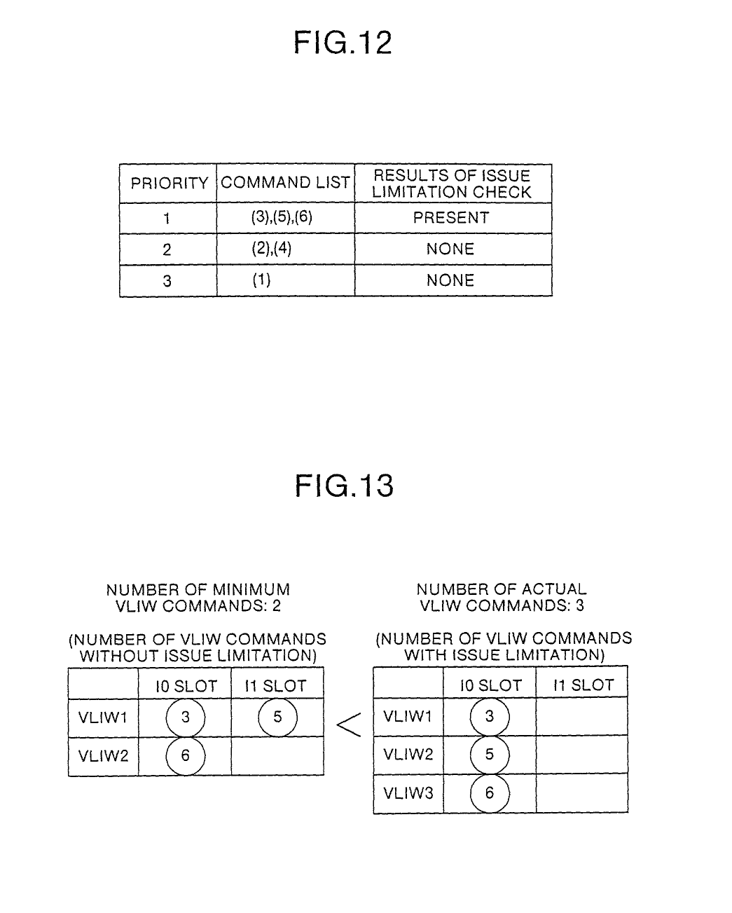

Returning to FIG. 9, with respect to the respective groups having the priority values of 1, 2 and 3, a check is made to see whether there is any issue limitation among commands in each of the groups (step S93). In the model shown in FIG. 10, as illustrated in FIG. 12, the group of priority 1 has an issue limitation, and the respective groups of priority 2 and priority 3 have no issue limitation. Therefore, returning to FIG. 9, a check is made to see whether or not there is any delay due to the issue limitation with respect to the group of priority 1 (step S94). Here, since the respective groups of priority 2 and priority 3 have no issue limitation, it is not necessary to examine them as to the presence or absence of any delay due to issue limitation.

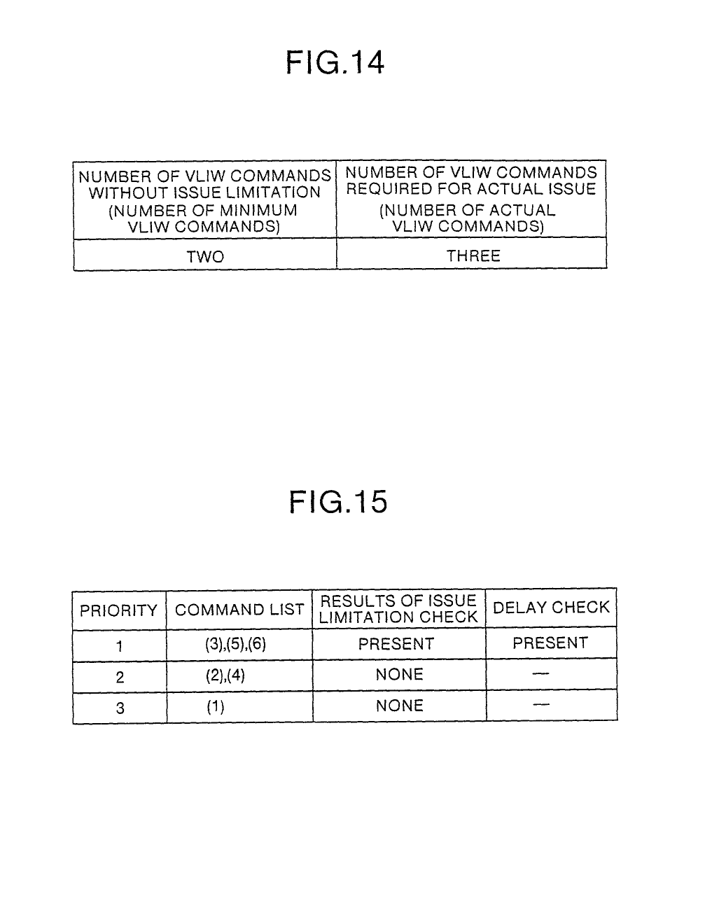

In order to check to see whether or not there is any delay due to the issue limitation, the number of actual VLIW commands and the number of minimum VLIW commands are found, and these are compared. In the model shown in FIG. 10, as illustrated in FIGS. 13 and 14, since command 3, command 5 and command 6 are issued only by I0 slot, the number of actual VLIW commands is 3. In contrast, since the number of minimum VLIW commands is 2, the aforementioned equation (2) is satisfied. Therefore, in the group of priority 1, a delay is generated due to the issue limitation; thus, the group of priority 1 is subjected to an optimizing process for issue limitation. In the present specification, the group with a priority value that is to be subjected to the optimizing process for issue limitation is referred to as “optimizing target group”. The results up to the present process are collectively shown in FIG. 15.

Successively, returning to FIG. 9, a neck command is obtained (step S95). Here, the neck command is a common precedent command of the commands contained in the optimizing target group (in the model shown in FIG. 10, the group of priority 1), and is used to find an effective range at the time when a weighting process, which will be described later, is executed. Upon issuance of the neck command, the commands within the optimizing target group are allowed to become independent from each other, that is, in a non-dependent relation ship.

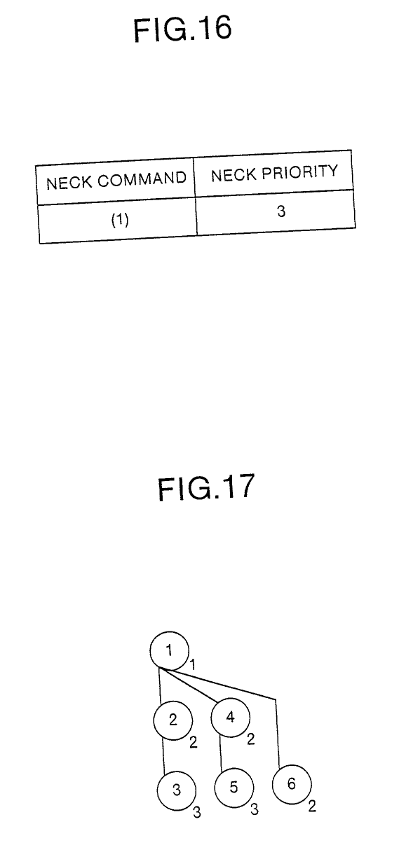

Here, the neck command is not necessarily a common command of all the commands in the optimizing target group, and may be common of some commands of the optimizing target group. When a plurality of common precedent commands exist in a certain optimizing target group, of those common precedent commands, that which has a minimum priority value is set as a neck command, and the priority value of the neck command is referred to as “neck priority value”. In the model shown in FIG. 10, the optimizing target group is the group of priority 1, and as illustrated in FIG. 16, the neck command is command 1, and the neck priority value is 3.

Returning to FIG. 9, based upon the aforementioned equation (3), the reverse priority calculations are executed (step S96). Here, as in case of the model of FIG. 10, if there is a neck command, the reverse priority value of the neck command will become 1. In other words, in the model shown in FIG. 10, no precedent command preceding the neck command exists; however, even when there is any precedent command before the neck command, no reverse priority calculation is executed with respect to the precedent command before the neck command.

As shown in FIG. 17, since command 1 is a neck command, its reverse priority value is 1. Each of the reverse priority values of command 2, command 4 and command 6 is 2, and each of the reverse priority values of command 3 and command 5 is 3. In the DAG shown in FIG. 17, the figures, located lower right of (1) to (6) representing nodes of the respective commands, indicate priority values.

Returning to FIG. 9, a plurality of commands contained in the optimizing target group are rearranged in the ascending order of the reverse priority values (step S97) At this time, when the reverse priority values are the same, those commands are rearranged in the ascending order of the number of precedent commands, and when the reverse priority values and the numbers of precedent commands are respectively the same, those commands are rearranged in the ascending order of the line numbers. Further, when the reverse priority values, the numbers of precedent commands and the line numbers are respectively the same, those commands are rearranged in the ascending order of the earlier generation times. Therefore, in the model shown in FIG. 10, they are arranged in the order of command 6, command 3 and command 5 (see FIG. 17).

Successively, each of the commands is subjected to a weighting process (step S98). There are two kinds of weighting values, the first weighting value, advantage, and the second weighting value, weight. The advantage is applied to those commands from the optimizing target group to the neck command. The weight is applied to those precedent commands preceding the neck command. Here, in the model shown in FIG. 10, since there is no command preceding command 1 that is a neck command, no weight is generated. Therefore, an explanation will be given only of the advantage, and an explanation of the weight will be given later.

With respect to the commands contained in the optimizing target group, a value obtained by subtracting 1 from the number of actual VLIW commands is set as the first advantage value, and the advantage value is reduced 1 by 1 for each of the commands in the order rearranged at step S97. With respect to the advantage of the precedent command of each of the commands contained in the optimizing target group, the advantage of the succeeding command following the precedent command is used as it is. When a plurality of succeeding commands exist, the greatest advantage, as it is, is used.

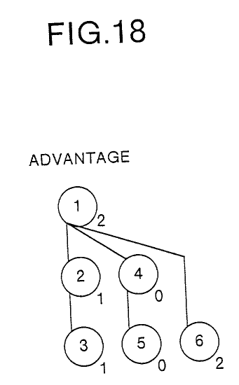

In the model shown in FIG. 10, the number of actual VLIW commands is 3 as described earlier, and the rearrangement is made at step S97 in the order of command 6, command 3 and command 5; therefore, as illustrated in FIG. 18, the advantages of command 6, command 3 and command 5 are 2, 1 and 0 (zero), respectively. Here, the advantage of command 2, which is inherited from that of command 3, is 1. In the same manner, the advantage of command 4, which is inherited from that of command 5, is 0 (zero). The advantage of command 1, which is inherited from command 6 having the greatest advantage of command 2, command 4 and command 6, is 2.

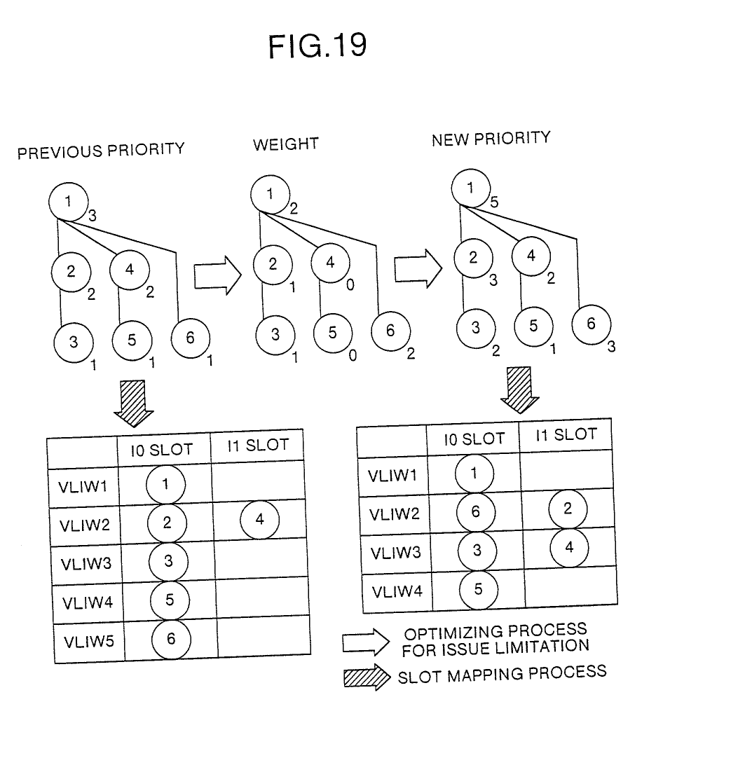

Successively, in FIG. 9, taking account of the weighting process carried out in step S98, the priority calculations are again carried out (step S99). Here, the priority calculations follow the aforementioned equation (4); however, the value obtained by adding an issue latency value and a penalty value to the priority value of the succeeding command is the same as the conventional priority value found at step S91. In other words, the new priority value is a value obtained by adding the weighting value to the previous priority value. Therefore, as shown on the upper row of FIG. 19, the new priority value of command 1 is 5 (=3+2), the new priority value of command 2 is 3 (=2+1), the new priority value of the command 3 is 2 (=1+1), the new priority value of the command 4 is 2 (=2+0), the new priority value of command 5 is 1 (=1+0), and the new priority value of command 6 is 3 (=1+2).

Returning to FIG. 9, based upon the new priority values of the respective commands, a ready list is formed, and a slop mapping process is carried out (step S100), thereby completing the scheduling. The order of slot mapping of the respective commands is made in the descending order of the new priority values, and when the new priority values are the same, it is made in the ascending order of the numbers of the succeeding commands. In the model shown in FIG. 10, the slot mapping is made in the order of command 1, command 6, command 2, command 3, command 4 and command 5.

Therefore, as shown on the right side of the lower row of FIG. 19, in the pseudo machine table, I0 slot issues command 1 in a certain cycle. At this time, no command is issued from I1 slot. Then, in the next cycle, I0 slot and I1 slot respectively issue command 6 and command 2; in the succeeding cycle, I0 slot and I1 slot issue command 3 and command 4 respectively; and in the succeeding cycle, I0 slot issues command 5. In other words, 6 commands, command 1 to command 6, are issued in four cycles.

Here, for comparative purposes, the results of the slot mapping that are carried out based upon the conventional priority values prior to the weighting process are shown on the left side of the lower row of FIG. 19. In this case, the slot mapping is made in the order of command 1, command 2, command 4, command 3, command 5 and command 6; thus, the total five cycles are required.

When no issue limitation is generated at step S93, or when there is no delay due to issue limitation at step S94, a ready list is formed and a slot mapping process (step S100) is carried out, by using the conventional priority values calculated at step S91, thereby completing the scheduling.

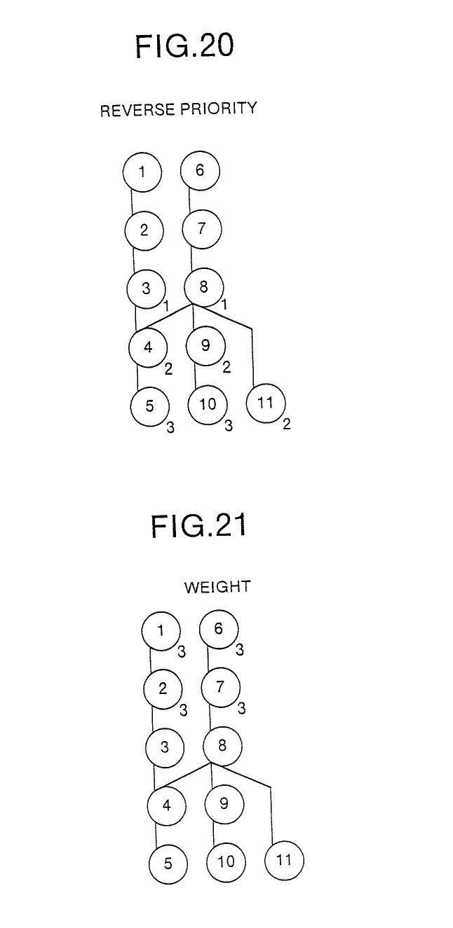

Next, referred to a model shown in FIG. 20, an explanation will be given of the weight. In the model of FIG. 20, command 1 (indicated by (1)) is dependent on command 2 (indicated by (2)). Command 2 is dependent on command 3 (indicated by (3) Command 3 is dependent on command 4 (indicated by (4)). Command 4 is dependent on command 5 (indicated by (5)). Command 6 (indicated by (6)) is dependent on command 7 (indicated by (7)). Moreover, command 7 is dependent on command 8 (indicated by (8)). Command 8 is dependent on command 4, command 9 (indicated by (9)) and command 11 (indicated by a circle around 11). Command 9 is dependent on command 10 (indicated by a circle around 10).

In the model of FIG. 20, the commands contained in the optimizing target group are command 5, command 10 and command 11, and the neck command is command 8. The reverse priority value of each of command 3 and command 8 is 1. The reverse priority value of each of command 4, command 9 and command 11 is 2. The reverse priority value of each of command 5 and command 10 is 3.

The weight is applied to precedent commands preceding the neck command, that is, to those commands having a priority value greater than the neck priority. The weight is equal to the number of actual VLIW commands of the optimizing target group following immediately after the command to which the weight is applied. Thus, the weight of the precedent command inherited from the weight of the succeeding command as it is. Therefore, in the model of FIG. 20, since the number of actual VLIW commands of the optimizing target group (command 5, command 10 and command 11) is 3, the weight of command 2 and command 7 that precede the neck command (command 8) is set to 3, as shown in FIG. 21. With respect to command 1 and command 6 that precede command 2 and command 7, since they follow the weight of command 2 and command 7, the weight thereof is 3.

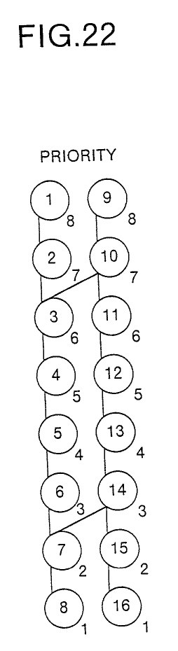

Here, when a new weight is generated due to another optimizing target group, this is applied to the weight. With respect to this process, for example, referring to a model shown in FIG. 22, a detailed explanation will be given. In the model of FIG. 22, command 1 (indicated by (1)) is dependent on command 2 (indicated by (2)). Command 2 is dependent on command 3 (indicated by (3)). Command 3 is dependent on command 4 (indicated by (4)). Command 4 is dependent on command 5 (indicated by (5)). Command 5 is dependent on command 6 (indicated by (6)). Command 6 is dependent on command 7 (indicated by (7)).

Moreover, command 7 is dependent on command 8 (indicated by (8)). Command 9 (indicated by (9)) is dependent on command 10 (indicated by a circle around 10). Command 10 is dependent on command 3 and command 11 (indicated by a circle around 11). Command 11 is dependent on command 12 (indicated by a circle around 12). Command 12 is dependent on command 13 (indicated by a circle around 13). Command 13 is dependent on command 14 (indicated by a circle around 14). Command 14 is dependent on command 7 and command 15 (indicated by a circle around 15). Command 15 is dependent on command 16 (indicated by a circle around 16).

In this model, the commands contained in the first optimizing target group are command 8 and command 16, and the neck command to the first optimizing target group is command 14. Moreover, in the model, command 4 and command 12 are contained in the second optimizing target group which has command 10 as its neck command.

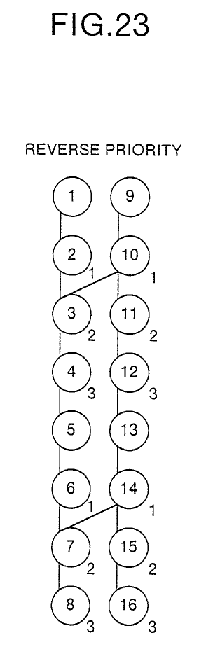

In the model shown in FIG. 22, the conventional priority value of command 8 and command 16 is 1. Then, the conventional priority value is increased 1 by 1 in succession from command 8 to command 1 as well as from command 16 to command 9; thus, the priority value of command 1 and command 9 is 8. With respect to the model of this type, as illustrated in FIG. 23, the reverse priority value is 3 in command 8, command 16, command 4 and command 12, and the reverse priority value is 2 in command 7, command 15, command 3 and command 11, and the reverse priority value is 1 in command 6, command 14, command 2 and command 10.

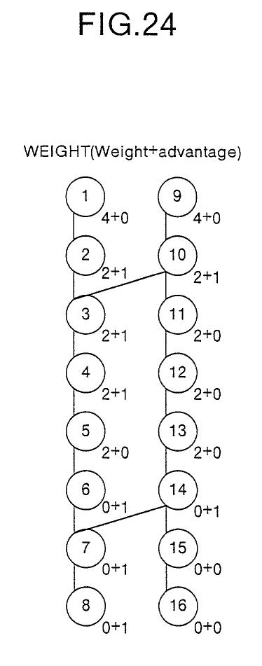

As illustrated in FIG. 24, the weight, applied to the model shown in FIG. 22, is 0 (zero) in case of command 6 to command 8 and command 14 to command 16. Since the number of actual VLIW commands is 2 in command 8 and command 16 within the first optimizing target group, command 5 and command 13, which are precedent commands before command 14 that is a neck command, have a weight of 2. Since this weight value is inherited by the further preceding commands, the weight of command 2 to command 4 and command 10 to command 12 is also 2. Moreover, the weight of 2, applied due to the first optimizing target group, is also inherited by preceding command 1 and command 9.

Moreover, since the number of actual VLIW commands is 2 in command 4 and command 12 within the second optimizing target group, a weight of 2, derived from the second optimizing target group, is newly added to the weight of command 1 and command 9 that are precedent commands of command 10 that is a neck command corresponding to the second optimizing target group. Therefore, the weight of command 1 and command 9 is set to 4 by adding 2 that is applied due to the first optimizing group and 2 that is applied due to the second optimizing group. Here, in the DAG shown in FIG. 24, among equations on the right below of (1) to a circle around 16 representing the nodes of the respective commands, figures on the left side of “+” represent weights and figures on the right side thereof represent advantages. The actual weighting value to be applied to each of the commands is formed by adding the weight and advantage of each of the commands.

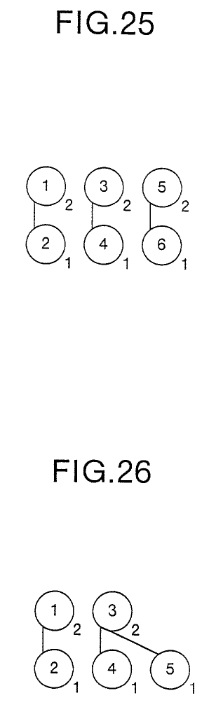

Next, an explanation will be given of a case in which, in the compiler parallelizing schedule method of the present invention, the optimizing process for issue limitation is not carried out. When any one of the following conditions (1) to (3) is applied, the optimizing process for issue limitation is not carried out due to the possibility of degradation in the optimizing function for issue limitation. (1) No precedent command exists in commands within an optimizing target group. (2) Although a neck command exists, no command exists between the priority of the optimizing target group and the neck priority. (3) Although a neck command exists, there is any command that is not a precedent command of an optimizing target group between the priority of the optimizing target group and the neck priority. For example in a model shown in FIG. 25, command 1 (indicated by (1)) is dependent on command 2 (indicated by (2)). Command 3 (indicated by (3)) is dependent on command 4 (indicated by (4)). Command 5 (indicated by (5)) is dependent on command 6 (indicated by (6)). The priority value of command 2, command 4 and command 6 is 1. The priority value of command 1, command 3 and command 5 is 2. Here, the commands contained in an optimizing target group are command 1, command 3 and command 5. Since this model corresponds to the above-mentioned condition (1), the optimizing process for issue limitation is not carried out.

Moreover, in a model shown in FIG. 26, command 1 (indicated by (1)) is dependent on command 2 (indicated by (2)). Command 3 (indicated by (3)) is dependent on command 4 (indicated by (4)) and command 5 (indicated by (5)). The priority value of command 2, command 4 and command 5 is 1. The priority value of command 1 and command 3 is 2. Here, the commands contained in an optimizing target group are command 2, command 4 and command 5, and the corresponding neck command is command 3. Since this model corresponds to the above-mentioned condition (2), the optimizing process for issue limitation is not carried out.

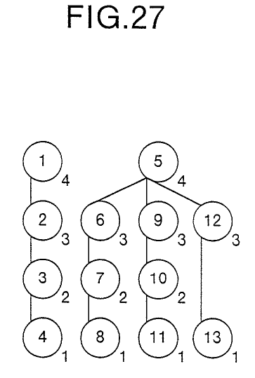

Moreover, in a model shown in FIG. 27, command 1 (indicated by (1)) is dependent on command 2 (indicated by (2)). Command 2 is dependent on command 3 (indicated by (3)). Command 3 is dependent on command 4 (indicated by (4)). Command 5 (indicated by (5)) is dependent on command 6 (indicated by (6)), command 9 (indicated by (9)) and command 12 (indicated by a circle around 12). Command 6 is dependent on command 7 (indicated by (7)). Command 7 is dependent on command 8 (indicated by (8)).

Command 9 is dependent on command 10 (indicated by a circle around 10). Command 10 is dependent on command 11 (indicated by a circle around 11). Command 12 is dependent on command 13 (indicated by a circle around 13). The priority value of command 4, command 8, command 11 and command 13 is 1. The priority value of command 3, command 7 and command 10 is 2. The priority value of command 2, command 6, command 9 and command 12 is 3. The priority value of command 1 and command 5 is 4. Here, the commands contained in an optimizing target group are command 3, command 7 and command 10, and the corresponding neck command is command 5. This model corresponds to the above-mentioned condition (3); that is, between the priority of the optimizing target group and the neck priority, there is a command that is not dependent on commands within the optimizing target group, which is command 12 in the example of the Figure, the optimizing process for issue limitation is not carried out.

In accordance with the above-mentioned embodiments, with respect to the command group classified for each of the conventional priority values, it is examined whether or not there is any issue limitation between commands within each command group, and with respect to a command group having any issue limitation, it is examined whether or not there is any delay due to the issue limitation; therefore, as compared with a case in which the parallel operation suppression relationship is examined with respect to nodes of all the commands, it is possible to carry out a parallelizing process on the object codes at higher speeds. Moreover, in accordance with the above-mentioned embodiment, the reverse priority calculations and the calculations for applying the advantage are executed in a range from the optimizing target group to the neck command; therefore, as compared with a case in which the parallel operation suppression relationship is examined with respect to nodes of all the commands, it is possible to carry out a parallelizing process on the object codes at higher speeds.

Furthermore, the advantage is applied to the commands from the optimizing target group to the neck command, and the weight is applied to the precedent commands preceding the neck command. Therefore, as compared with a case in which the weighting value to be applied to the commands is only the parallel operation suppressing number, it is possible to improve the degree of parallelism in the object codes.

In accordance with the present invention, with respect to the command group classified for each of the conventional priority values, it is examined whether or not there is any issue limitation between commands within each command group, and with respect to a command group having any issue limitation, it is examined whether or not there is any delay due to the issue limitation, and the reverse priority calculations and the calculations for applying the first weighting value are executed in a range from the optimizing target group to the neck command. Therefore, it is possible to carry out a parallelizing process on the object codes at higher speeds. Moreover, in accordance with the present invention, the first weighting value is applied to commands from the optimizing target group to the neck command, and the second weight is applied to the precedent commands preceding the neck command; therefore, it is possible to improve the degree of parallelism in the object codes.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A compiler parallelizing schedule method comprising the steps of:
calculating a priority value of each of commands based upon mutual dependence between commands;
calculating a reverse priority value corresponding to the shortest command ending time for each of the commands;
weighting each of the commands based upon the reverse priority value; and
calculating a new priority value for each of the commands based upon the weighting value applied to each of the commands and the priority value of each of the commands.

2. A compiler parallelizing schedule method comprising the steps of:
calculating a priority value of each of commands based upon mutual dependence between commands;
checking to see whether or not there is any delay between the commands having the same priority value due to an issue limitation;
when any delay exists due to an issue limitation, calculating a reverse priority value corresponding to the shortest command ending time for each of the commands;
weighting each of the commands based upon the reverse priority value;
calculating a new priority value for each of the commands based upon the weighting value applied to each of the commands and the priority value of each of the commands; and
determining an issuing order of the commands based upon the new priority values, thereby slot-mapping the respective commands.

3. The compiler parallelizing schedule method according to claim 2,
wherein a group of the commands, each having any delay due to an issue limitation, is defined as an optimizing target group, a common precedent command of a plurality of commands contained in the optimizing target group is defined as a neck command, and the reverse priority value is found between the neck command and the optimizing target group.

4. The compiler parallelizing schedule method according to claim 3,
wherein the weighting values include a first weighting value that is applied to the commands from the optimizing target group to the neck command and a second weighting value that is applied to precedent commands preceding the neck command.

5. The compiler parallelizing schedule method according to claim 4,
wherein with respect to a plurality of commands contained in the optimizing target group, an order of priority is set in an ascending order of the reverse priority values, in an ascending order of the number of the precedent commands when the reverse priority values are the same, in an ascending order of line numbers when the reverse priority value and the number of the precedent commands are the same, and in an ascending order of generation times when the reverse priority value, the number of precedent orders and the line number are the same, and in accordance with the order of priority, the first weighting value is determined.

6. The compiler parallelizing schedule method according to claim 5,
wherein in accordance with the order of priority, the first weighting value for the first command is set to a value obtained by subtracting 1 from the number of commands required for issuing the commands within the optimizing target group while taking into consideration the actual issue limitation, and the first weighting value for the commands of the second one and thereafter is set to a value obtained by successively reducing 1 from the value obtained by subtracting 1 from the number of commands.

7. The compiler parallelizing schedule method according to claim 5,
wherein the first weighting value for the precedent commands to the respective commands within the optimizing target group is set to a value that is inherited from the first weighting value for succeeding commands following the precedent commands, and when a plurality of succeeding commands exist, it is set to a value that is inherited from the greatest first weighting value.

8. The compiler parallelizing schedule method according to claim 4,
wherein the second weighting value for the precedent command to the neck command is set to a value that is inherited from the number of commands required for issuing the commands within the optimizing target group corresponding to the neck command while taking into consideration the actual issue limitation.

9. The compiler parallelizing schedule method according to claim 4,
wherein when a new second weighting value is generated resulting from another optimizing target group different from the optimizing target group corresponding to the neck command, the second weighting value for the precedent command to the neck command is set to a value that is obtained by adding the second weighting value.

10. The compiler parallelizing schedule method according to claim 2,
wherein when there is an issue limitation between commands having the same priority value, the number of commands required for issuing the commands having the same priority value in accordance with the actual issue limitation and the number of commands required for issuing the commands having the same priority value on the assumption that there is no issue limitation are found, and the numbers of commands are compared with each other so that, when the number of commands required for issuing the commands having the same priority value in accordance with the actual issue limitation is greater, it is judged that there is a delay due to the issue limitation.

11. The compiler parallelizing schedule method according to claim 3,
wherein in any of cases in which no precedent command exists in commands within an optimizing target group, no command exists between the priority value of the optimizing target group and the priority value of the neck command, and there is any command that is not a precedent command of an optimizing target group between the priority value of the optimizing target group and the priority value of the neck command, none of the calculating process of the reverse priority values, the weighting process and the calculating process of the new reverse priority values are carried out, and based upon the priority values first found, the order of issue of commands is determined so as to carry out slot mapping of the respective commands.
